(19) United States
(12) Patent Application Publication
(10) Pub. No.: US 2004/0087684 A1
(43) Pub. Date: May 6, 2004

(54) Epoxy resin coating compositions containing fibers, and methods of using the same

(76) Inventors: Rainer Hoefer, Duesseldorf (DE); Thorsten Roloff, Duesseldorf (DE); Horst Sulzbach, Duesseldorf (DE)

Correspondence Address: COGNIS CORPORATION, PATENT DEPARTMENT, 300 BROOKSIDE AVENUE, AMBLER, PA, 19002, US

(21) Appl. No.: 10/398,311

(22) PCT Filed: Sep. 28, 2001
(86) PCT No.: PCT/EP01/11241

(30) Foreign Application Priority Data
Oct. 7, 2000 (DE) 100 49 654.7

(51) Int. Cl. C08L 63/00

(52) U.S. Cl. 523/400

(57) ABSTRACT

Coating compositions comprising: (a) an epoxy resin in an amount of from 5 to 50% by weight, the epoxy resin comprising a reaction product of epichlorohydrin and a component selected from the group consisting of bisphenol A and bisphenol F; (b) a water-dilutable epoxy resin hardener in an amount of from 5 to 55% by weight; (c) fibers in an amount of from 0.1 to 10% by weight; and (d) a filler in an amount of from 5 to 70% by weight; are described, along with their use as levelling, insulating and other functional coatings.

### FIELD OF THE INVENTION

This invention relates to coating compositions.

### PRIOR ART

The use of synthetic polymeric binders has long been traditional in the building industry. With the beginning of industrial emulsion polymerization and the increasing availability of stable thermoplastic synthetic resin dispersions in the fifties, a twin-track development program was initiated, for example, in the paint and facade plaster sector. Emulsion paints on the one hand were mixed with coarse fillers and sands and applied in thick layers to obtain special surface textures. This gave rise to the first spreading plasters, roller-applied plasters and grooving plasters. On the other hand, elastomeric synthetic resin dispersions were added to mineral mortars to improve their adhesion properties, their resistance to moisture and their mechanical properties. This led to improved mineral plasters and finally to pure synthetic resin plasters which do not contain any chemically setting components, such as lime, cement or waterglass.

In addition, the use of thermoset polymeric binder systems, for example in the form of water-free two-component systems of polyurethane, for the production of quick-setting insulating compounds, open-cell moldings and water-permeable paving setts is described in DE-A-39 32 406 and DE-A-43 20 118. The use of solvent-containing and solvent-free thermoset two-component epoxy systems as a technological alternative to two-component polyurethane systems for liquid casting resin applications, floor levelling compounds and concrete protection systems is known from the specialist literature (cf. for example: E. Foglianisi, R. Grützmacher, R. Höf r, Wofür eignen sich Fuβbodenbeschichtungen aus Polyurethan- und Epoxy-Harzen? Industriebau, Suppl. Industrie-Boden-Technik 43 [2], March/April 1997, pages 18-20); water-based systems are also mentioned here.

Water-based epoxy systems have long been known for cathodic electrodeposition painting in the automotive industry and also for can lacquers and anti-corrosion primers (cf. for example: J. L. Chou, Novel Corrosion-Resistant Waterborne Epoxy Coatings, Polymers Paint Colour Journal, 1994 (Vol. 184), pages 413 and 416-417).

In principle, epoxy resin emulsions may be prepared from the same surface-active compounds which have already been successfully used for the production of thermoplastic polymer dispersions by emulsion polymerization and which are described, for example, in C. Baumann, D. Feustel, U. Held, R. Höfer, Stabilisierungs systeme für die Herstellung von Polymer-Dispersionen, Welt der Farben, 2/1996, pages 15-21.

Special nonionic emulsifiers, for example Disponil 23, a product of Cognis Deutschland GmbH, Düssledorf/DE, are available for the practical production of epoxy resin secondary emulsions. Other highly effective emulsifiers can be obtained by protonating the polyaminoamides of unsaturated fatty acids already known as epoxy resin hardeners by addition of acetic acid and thus converting them into incorporable cationic emulsifiers and hardeners. Accordingly, these cationic polyaminoamides are also epoxy resin emulsifiers and epoxy resin hardeners. They develop their optimum effectiveness in the acidic pH range. Strong alkalis neutralize the cationic charge and reduce emulsifier activity which, on strongly basic cement surfaces for example, leads to rapid destabilization and early breaking of the emulsion so that, despite a certain tendency towards relatively high sensitivity of the hardened films to water, the above-mentioned nonionic and hence alkali-stable emulsifiers are still used in the priming and sealing of cement-bonded coatings and in the modification of hydraulically setting mortars.

### DESCRIPTION OF THE INVENTION

Although, as explained above, both solvent-containing and water-based epoxy resins were known to the expert and had already been used for some time for painting and coating purposes in the building industry, their use as insulating and levelling compounds was still hampered by inadequacies to the extent that the necessary combination of properties, such as good processability, alkali stability, imperviousness to water, early water resistance, adequate open times and, at the same time, easy recognizability of the end of processabiltiy, self-levelling behavior, high compressive strength, storage and sedimentation stability coupled with high filler binding capacity and ecotoxicological compatibility, is not achieved.

The problem addressed by the present invention was to provide insulating and levelling compounds which would be distinguished by improved performance properties by comparison with systems known from the prior art.

Levelling and insulating compounds in the context of the present invention are understood in particular to be floor coating compositions based on epoxy resins which, when applied to concrete, wood or other substrates, flow evenly and quickly and produce a smooth surface. They may also contribute to protection against sound and heat as defined in the provincial building codes (for example “Die neue Bauordnung für Hessen” published by Hessischer Städte- und Gemeinebund, Kommunale Schriften für Hessen 45, cited after H. Klopfer, Muβ man Industriefuβböden warmedämmen ? in Industriefuβböen '95, Techn. Akademie Esslingen, Ostfildern, 1995). It is clear from this definition that levelling and insulating compounds count as coating compositions.

The present invention relates to coating compositions containing

A) 5.0 to 50.0% by weight epoxy resins in the form of reaction products of bisphenol A and/or bisphenol F with epichlorohydrin,

B) 5.0 to 55.0% by weight water-dilutable epoxy resin hardeners,

C) 0.1 to 10.0% by weight fibers,

D) 0 or 0.1 to 5.0% by weight wax-based open-time extenders,

E) 0 or 0.1 to 5.0% by weight rheology additives,

F) 5.0 to 70.0% by weight fillers,

G) 0 or 0.1 to 20.0% by weight water and

H) 0 to 70% by weight other additives and/or processing aids,

the sum of the percentages by weight of components A) to H) coming to 100% by weight.

It is specifically pointed out with regard to components A) to F) that individual species or mixtures thereof may be used. Accordingly, both one and several epoxy resin(s) A), epoxy resin hardener(s) B), fibers C), open-time extender(s) D), rheology additive(s) E) and filler(s) F) may be used.

The coating compositions may be produced by any method known to the expert. In particular, the components may be successively mixed together. However, two or more components may also first be premixed and then contacted in that form with other components to form the final coating composition. This particular variant applies in particular to component G) (=water). Where it is used at all, water may be introduced in various ways into the system as a whole during the production of the coating compositions according to the invention. For example, commercially available compounds of classes A) to F) in particular may be used in water-containing supply forms. In other words, water may either be introduced as such with the other compulsory components of the coating composition or may even be introduced by using individual or all components A) to F) in water-containing supply forms or by a combination of both methods.

In a preferred embodiment, the coating compositions are produced by first mixing all components B) to H) to form a mixture (I) and then adding component A) to mixture (I). The ratio of mixture (I) to component A) is preferably selected so that the hardener B) present in (I) and component A) are present in an equimolar ratio in the resulting coating composition.

The percentages by weight for components A) to H) are all based on the respective active-substance contents. If, for example, a coating composition is prepared by using one or more components in water-containing supply forms, characterization of the composition of the coating composition as a whole is determined by the quantities of individual components—expressed as active substances—present and not by whether certain components were used in water-free or water-containing form during the production of the coating composition. Accordingly, the percentage content of component G), i.e. water, is always expressed as the sum total of water present in the coating composition as a whole.

Component A)

Component A) of the coating compositions according to the invention is formed by epoxy resins consisting of reaction products of bisphenol A and/or bisphenol F with epichlorohydrin. Reaction products such as these are known to the expert, cf. Julia Möckel, Udo Fuhrmann, Epoxidharze—Schlüsselwerkstoffe für die moderne Technik, Die Bibliothek der Technik, Vol. 51, Verlag moderne Industrie, 1990, pages 4-7. Here, it is mentioned in particular that the most common epoxy resins are condensation products of bisphenol A and epichlorohydrin, the length of the molecule chains formed in that reaction depending upon the molar ratio in which the starting components are used and being described by the index n. The molecular weight and, at the same time, the viscosity of the compounds increase with increasing chain length. Unmodified resins of this type are liquid in consistency at 20° C. (room temperature) where 0>n>1 whereas n has a value of 2 to 13 or more in the corresponding solid resins. The corresponding bishenol F resins are also mentioned in this publication.

The liquid unmodified bis-A and bis-F epoxy resins are solvent-free, easy to process and typically have viscosities in the range from 5,000 to 15,000 mPas and preferably in the range from 5,000 to 10,000 mPas (both here and in the following, viscosities are based on measurements at 20° C. with a Brookfield viscosimeter). They are commercially available, for example under the name of Chem-Res E 30 (Henkel S. p. A., Milan/it.).

If desired, the viscosity of such resins can be further reduced, for example to 200 mPas, by addition of reactive diluents. Resins diluted by reactive diluents are also commercially available, for example under the name of Chem-Res E 97 (Henkel S. p. A., Milan/It.). In the context of the present invention, such resins would be mixtures of components A) and E) because reactive diluents count as rheology additives.

In one embodiment, epoxy resins liquid at 20° C. of the type mentioned above (reaction products of bisphenol A and/or bisphenol F with epichlorohydrin) are used as component A).

Reaction products of bisphenol A with epichlorohydrin liquid at 20° C. are preferably used as component A).

In one embodiment, component A) is used in a quantity of 5 to 30% by weight.

Component B)

Component B) of the coating compositions according to the invention is a water-dilutable epoxy resin hardener. Compounds derived from adducts based on α,β-unsaturated carboxylic acid esters and mono-, di- or polyaminopolyalkylene oxide compounds are preferably used as component B). The compounds B) are preferably selected from the group of types B1) to B3) described hereinafter.

Hardeners of the B1) Type are Obtainable by

(a) Reacting One or More α,β-Unsaturated Carboxylic Acid Esters (I)

R²R³C═C(R ⁴)COOR¹ (I)

where R¹ is an aromatic or aliphatic radical containing up to 15 carbon atoms, the substituents R², R³ and R⁴ independently of one another represent hydrogen, branched or unbranched, aliphatic or aromatic groups containing up to 20 carbon atoms or a group —(CH₂)ₙ—COOR¹, where R¹ is as defined above and n is a number of 0 to 10, in the presence of a transesterification catalyst with (b) one or more hydroxy compounds, compounds (a) and (b) being used in such quantities that the equivalent ratio of the hydroxyl groups in (b) to the ester groups COOR¹ in the α,β-unsaturated carboxylic acid esters (a) is in the range from 1.5:1 to 10:1,

reacting the intermediate product Z1 obtained with

(c) one or more mono-, di- or polyaminopolyalkylene oxide compounds, an equivalent ratio of the reactive hydrogen atoms at the aminonitrogen atoms of (c) to the ester groups in the intermediate compound Z1 in the range from 10:1 to 1:10 being adjusted,

subsequently reacting the intermediate product Z2 obtained with

(d) one or more polyepoxides, the equivalent ratio of oxirane rings in polyepoxide (d) to reactive hydrogen atoms of the mono-, di- or polyaminopolyalkylene oxide compounds used in (c) being adjusted to a value of 100:1 to 1.5:1,

and subsequently reacting the intermediate product Z3 obtained with

(e) one or more primary and/or secondary amines, the equivalent ratio of oxirane rings in the intermediate product Z3 to the reactive H atoms at the aminonitrogen atoms of (e) being adjusted to a value of 1:1.5 to 1:20.

The hardeners according to the invention are either liquid or solid substances, depending on their molecular weight.

The expression “equivalent ratio” is familiar to the expert. The basic concept behind the notion of the equivalent is that, for every substance participating in a reaction, the reactive groups involved in the desired reaction are taken into consideration. By indicating an equivalent ratio, it is possible to express the ratio which all the various reactive groups of the compounds (x) and (y) used bear to one another. It is important in this connection to bear in mind that a reactive group is understood to be the smallest possible reactive group, i.e. the notion of the reactive group is not identical with the notion of the functional group. In the case of H-acid compounds, this means for example that, although OH groups or NH groups represent such reactive groups, NH₂ groups with two reactive H atoms positioned at the same nitrogen atom do not. In their case, the two hydrogen atoms within the functional group NH₂ are appropriately regarded as reactive groups so that the functional group NH₂ contains two reactive groups, namely the hydrogen atoms.

In one embodiment, the intermediate compound Z1 and the compound (c) are used in such quantities that the equivalent ratio of reactive hydrogen atoms at the aminonitrogen atoms of (c) to the ester groups in the intermediate compound Z1 is in the range from 4:1 to 1:4 and more particularly in the range from 2.5:1 to 1.5:1.

In another embodiment, the equivalent ratio of oxirane rings in the polyepoxide (d) to reactive hydrogen atoms of the mono-, di- or polyaminopolyalkylene oxide compounds used in (c) is adjusted to a value in the range from 50:1 to 10:1.

Examples of the α,β-unsaturated carboxylic acid esters (a) corresponding to formula (I) to be used in accordance with the invention are methyl acrylate, ethyl acrylate, dimethyl maleate, diethyl maleate, dimethyl fumarate, diethyl fumarate, dimethyl itaconate, diethyl itaconate. Particularly preferred compounds (a) are dialkyl maleates, more particularly diethyl maleate and dimethyl maleate.

The hydroxy compounds (b) may be aliphatic or aromatic. The compounds (b) should be inert to transesterification catalysts.

Examples of suitable aromatic compounds (b) are resorcinol, hydroquinone, 2,2-bis-(4-hydroxyphenyl)-propane (bisphenol A), isomer mixtures of dihydroxydiphenyl methane (bisphenol F), tetrabromobisphenol A, 4,4′-dihydroxydiphenyl cyclohexane, 4,4′-dihydroxy-3,3-dimethyldiphenyl propane, 4,4′-dihydroxydiphenyl, 4,4′-dihydroxybenzophenol, bis-(4-hydroxyphenyl)-1,1-ethane, bis-(4-hydroxyphenyl)-1,1-isobutane, bis-(4-hydroxyphenyl)-methane, bis-(4-hydroxyphenyl)-ether, bis-(4-hydroxyphenyl)-sulfone etc. and the chlorination and bromination products of the above-mentioned compounds. Bisphenol A is the preferred aromatic compound (b).

In one preferred embodiment, the hydroxy compounds (b) are selected from the class of fatty alcohols, alkanediols and polyetherdiols. If desired, these compounds may also be alkoxylated.

The fatty alcohols are primary alcohols containing 6 to 36 carbon atoms which may be saturated or olefinically unsaturated. Examples of suitable fatty alcohols are hexanol, heptanol, octanol, pelargonyl alcohol, decanol, undecanol, lauryl alcohol, tridecanol, myristyl alcohol, pentadecanol, palmityl alcohol, heptadecanol, stearyl alcohol, nonadecanol, arachidyl alcohol, heneicosanol, behenyl alcohol, tricosanol, lignoceryl alcohol, 10-undecanol, oleyl alcohol, elaidyl alcohol, ricinolyl alcohol, linoleyl alcohol, linolenyl alcohol, gadoleyl alcohol, arachidonyl alcohol, erucyl alcohol, brassidyl alcohol.

The alkanediols are compounds corresponding to the general formula HOCH₂—R⁵—CH₂OH, where R⁵ is a hydrophobic hydrocarbon radical which may be saturated or unsaturated, linear or branched and may also contain aromatic structural elements. Examples are hexane-1,6-diol, heptane-1,7-diol and octane-1,8-diol, polyoxytetramethylenediols—also known as polytetrahydrofurans—and the so-called dimerdiols. Dimer diols are most particularly preferred for the purposes of the present invention.

Dimerdiols are well-known commercially available compounds which are obtained, for example, by reduction of dimer fatty acid esters. The dimer fatty acids on which these dimer fatty acid esters are based are carboxylic acids which may be obtained by oligomerization of unsaturated carboxylic acids, generally fatty acids, such as oleic acid, linoleic acid, erucic acid and the like. The oligomerization is normally carried out at elevated temperature in the presence of a catalyst, for example of clay. The substances obtained—dimer fatty acids of technical quality—are mixtures in which the dimerization products predominate. However, small amounts of higher oligomers, more particularly the trimer fatty acids, are also present. Dimer fatty acids are commercially available products and are marketed in various compositions and qualities. Abundant literature is available on the subject of dimer fatty acids, cf. for example the following articles: Fette & Öle 26 (1994), pages 47-51; Speciality Chemicals 1984 (May Number), pages 17, 18, 22-24. Dimerdiols are well-known among experts, cf. for example a more recent article in which inter alia the production, structure and chemistry of the dimerdiols are discussed: Fat Sci. Technol. 95 (1993), No. 3, pages 91-94. According to the invention, preferred dimerdiols are those which have a dimer content of at least 50% and more particularly 75% and in which the number of carbon atoms per dimer molecule is mainly in the range from 36 to 44.

Polyetherdiols in the context of the present invention are diols corresponding to the general formula HOCH₂—R⁶—CH₂OH, where R⁶ is a hydrophobic hydrocarbon radical which may be saturated or unsaturated, linear or branched and may also contain aromatic structural elements and in which one or more CH₂ units must each be replaced by an oxygen atom.

A particularly attractive class of polyetherdiols can be obtained by alkoxylation of alkanediols, such as ethane-1,2-diol, propane-1,3-diol, propane-1,2-diol, butane-1,4-diol, butane-1,3-diol, pentane-1,5-diol, hexane-1,6-diol, heptane-1,7-diol and octane-1,8-diol, polyoxytetramethylenediols (polytetrahydrofurans) and dimerdiols. The production of these alkoxylated diols is normally carried out as follows: in a first step, the required diol is contacted with ethylene oxide and/or propylene oxide and the resulting mixture is reacted in the presence of an alkaline catalyst at temperatures of 20 to 200° C. Addition products of ethylene oxide (EO) and/or propylene oxide (PO) onto the diol used are obtained in this way. The addition products are therefore EO adducts or PO adducts or EO/PO adducts with the particular diol; in the case of the EO/PO adducts, the addition of EO and PO may take place statistically or blockwise.

Suitable transesterification catalysts for the reaction of the compounds (a) and (b) are any transesterification catalysts known to the expert from the prior art. Examples of suitable catalysts are sodium methylate, dibutyl tin diacetate, tetraisopropyl orthotitanate. If desired, the catalysts may be deactivated after the transesterification although this is not absolutely essential.

Suitable amino components (c) are mono-, di- or polyaminopolyalkylene oxide compounds. By this is meant that these compounds contain, on the one hand, one, two or more amino functions (NH or NH₂ functions) and, on the other hand, alkylene oxide units. The alkylene oxide units are, in particular, ethylene oxide, propylene oxide and butylene oxide, ethylene oxide and propylene oxide being particularly preferred. The compounds (c) are substances at least partly soluble in water at 20° C.

The production of the compounds (c) is known from the prior art and comprises the reaction of hydroxyfunctional compounds with alkylene oxides and subsequent conversion of the resulting terminal hydroxyl groups into amino groups.

So far as the reaction of hydroxyfunctional compounds with alkylene oxides is concerned, ethoxylation and propoxylation are of particular importance. The following procedure is usually adopted: in a first step, the required hydroxyfunctional compounds are contacted with ethylene oxide and/or propylene oxide and the resulting mixture is reacted in the presence of an alkaline catalyst at temperatures in the range from 20 to 200° C. Addition products of ethylene oxide (EO) and/or propylene oxide (PO) are obtained in this way. The addition products are preferably EO adducts or PO adducts or EO/PO adducts with the particular hydroxyfunctional compound. In the case of the EO/PO adducts, the addition of EO and PO may be carried out statistically or blockwise.

In one embodiment, substances with the general formula R⁸-O-R⁹—CH₂CH(R¹⁰)—NH₂ are used as the compounds (c). In this formula:

R⁸ is a monofunctional organic group containing 1 to 12 carbon atoms which may be aliphatic, cycloaliphatic or aromatic,

R⁹ is a polyoxyalkylene group made up of 5 to 200 polyoxyalkylene units, more particularly EO and/or PO units,

R¹⁰ is hydrogen or an aliphatic radical containing up to 4 carbon atoms.

Particularly suitable representatives of the compounds (c) for the purposes of the present invention are the “Jeffamines” known to the expert which are commercially available substances. One example is “Jeffamine 2070” which, according to the manufacturer Texaco, is produced by reacting methanol with ethylene oxide and propylene oxide and then converting the terminal hydroxyl groups of the intermediate product initially obtained into amine groups (cf. WO 96/20971, page 10, lines 12-15).

The compounds (c) preferably have average molecular weights (number average Mn) of 148 to 5,000 and more particularly in the range from 400 to 2,000.

The epoxy compounds (d) are polyepoxides containing on average at least two epoxy groups per molecule. These epoxy compounds may be both saturated and unsaturated and aliphatic, cycloaliphatic, aromatic and heterocyclic and may also contain hydroxyl groups. They may also contain substituents which do not cause any troublesome secondary reactions under the mixing and reaction conditions, for example alkyl or aryl substituents, ether groups and the like. These epoxy compounds are preferably polyglycidyl ethers based on polyhydric, preferably dihydric, alcohols, phenols, hydrogenation products of these phenols and/or novolaks (reaction products of mono- or polyhydric phenols with aldehydes, more particularly formaldehyde, in the presence of acidic catalysts). The epoxy equivalent weights of these epoxy compounds are preferably between 160 and 500 and more preferably between 170 and 250. The epoxy equivalent weight of a substance is the quantity of the substance (in grams) which contains 1 mole of oxirane rings. Preferred polyhydric phenols are the following compounds: resorcinol, hydroquinone, 2,2-bis-(4-hydroxyphenyl)-propane (bisphenol A), isomer mixtures of dihydroxydiphenyl methane (bisphenol F), tetrabromobisphenol A, 4,4′-dihydroxydiphenyl cyclohexane, 4,4′-dihydroxy-3,3-dimethyldiphenyl propane, 4,4′-dihydroxydiphenyl, 4,4′-dihydroxybenzophenol, bis-(4-hydroxyphenyl)-1,1-ethane, bis-(4-hydroxyphenyl)-1, 1-isobutane, bis-(4-hydroxyphenyl)methane, bis-(4-hydroxyphenyl)-ether, bis-(4-hydroxyphenyl)-sulfone etc. and the chlorination and bromination products of the above-mentioned compounds. Bisphenol A is most particularly preferred.

Bisphenol A

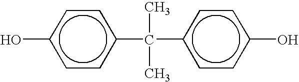

The polyglycidyl ethers of polyhydric alcohols are also suitable compounds (d). Examples of such polyhydric alcohols are ethylene glycol, diethylene glycol, triethylene glycol, 1,2-propylene glycol, polyoxypropylene glycols (n=1-20), 1,3-propylene glycol, 1,4-butylene glycol, pentane-1,5-diol, hexane-1,6-diol, hexane-1,2,6-triol, glycerol and bis-(4-hydroxycyclohexyl)-2,2-propane.

Other suitable compounds (d) are polyglycidyl ethers of polycarboxylic acids obtained by reaction of epichlorohydrin or similar epoxy compounds with an aliphatic, cycloaliphatic or aromatic polycarboxylic acid, such as oxalic acid, succinic acid, adipic acid, glutaric acid, phthalic acid, terephthalic acid, hexahydrophthalic acid, 2,6-naphthalenedicarboxylic acid and dimerized linolenic acid. Examples are adipic acid diglycidyl ester, phthalic acid diglycidyl ester and hexahydrophthalic acid diglycidyl ester.

A comprehensive list of suitable epoxy compounds (d) can be found in:

A. M. Paquin, “Epoxidverbindungen und Epoxidharze”, Springer-Verlag, Berlin 1958, Chapter V, pages 308 to 461 and

Lee, Neville “Handbook of Epoxy Resins” 1967, Chapter 2, pages 201 and 2-33.

Mixtures of several epoxy compounds (d) may also be used,

Amines (e) suitable for the purposes of the invention are primary and/or secondary amines. Preferred amines (e) are polyamines containing at least two nitrogen atoms and at least two active aminohydrogen atoms per molecule. Aliphatic, aromatic, aliphatic-aromatic, cycloaliphatic and heterocyclic di- and polyamines may be used.

The following are examples of suitable amines (e): polyethylene amines (ethylene diamine, diethylene triamine, triethylene tetramine, tetraethylene pentamine, etc.), 1,2-propylene diamine, 1,3-propylene diamine, 1,4-butane diamine, 1,5-pentane diamine, 1,3-pentane diamine, 1,6-hexane diamine, 3,3,5-trimethyl-1,6-hexanediamine, 3,5,5-trimethyl-1,6-hexane diamine, 2-methyl-1,5-pentane diamine, bis-(3-aminopropyl)amine, N,N′-bis-(3-aminopropyl)-1,2-ethane diamine, N-(3-aminopropyl)-1,2-ethane diamine, 1,2-diaminocyclohexane, 1,3-diaminocyclohexane, 1,4-diaminocyclohexane, aminoethyl piperazines, the poly(alkylene oxide)diamines and triamines (such as, for example, Jeffamine D-230, Jeffamine D-400, Jeffamine D-2000, Jeffamine D-4000, Jeffamine T-403, Jeffamine EDR-148, Jeffamine EDR-192, Jeffamine C-346, Jeffamine ED-600, Jeffamine ED-900, Jeffamine ED-2001), meta-xylyene diamine, phenylene diamine, 4,4′-diaminodiphenyl methane, toluene diamine, isophorone diamine, 3,3′-dimethyl-4,4′-diaminodicyclohexyl methane, 4,4′-diaminodicyclohexylmethane, 2,4′-diaminodicyclohexyl methane, the mixture of poly(cyclohexylaromatic)amines attached by a methylene bridge (also known as MBPCM) and polyaminoamides.

Other suitable compounds (e) are the reaction products of the amines just mentioned with the above-described α,β-unsaturated carboxylic acid esters (a) and the reaction products of the amines just mentioned with the above-described polyepoxy compounds (d).

Hardeners of the B2) type are obtainable by

(a) reacting one or more α,β-unsaturated carboxylic acid esters (I):

R²R³C═C(R⁴)COOR¹ (I)

where R¹ is an aromatic or aliphatic radical containing up to 15 carbon atoms, the substituents R², R³ and R⁴ independently of one another represent hydrogen, branched or unbranched, aliphatic or aromatic groups containing up to 20 carbon atoms or a group —(CH₂)ₙ—COOR¹, where R¹ is as defined above and n is a number of 0 to 10, with

(c) one or more mono-, di- or polyaminopolyalkylene oxide compounds, compounds (a) and (c) being used in such quantities that the equivalent ratio of the reactive hydrogen atoms at the aminonitrogen atoms of (c) to the C═C double bond in the α,β-position to the group COOR¹ shown in formula (I) in the carboxylic acid esters (a) is in the range from 10:1 to 1:10,

subsequently reacting the intermediate product Z4 obtained with

(d) one or more polyepoxides, the equivalent ratio of oxirane rings in polyepoxide (d) to reactive hydrogen atoms in the mono-, di- or polyaminopolyalkylene oxide compounds (c) being adjusted to a value of 100:1 to 1.5:1,

and subsequently reacting the intermediate product Z5 obtained with

(e) one or more primary and/or secondary amines, the equivalent ratio of oxirane rings in the intermediate product Z5 to the reactive H atoms at the aminonitrogen atoms of (e) being adjusted to a value of 1:1.5 to 1:20.

The foregoing observations on hardeners of the B1) type otherwise apply to the substances (a) and to the substances (c) to (e).

Hardeners of the B3) type are obtainable by

(a) reacting one or more α,β-unsaturated carboxylic acid esters (I):

R²R³C═C(R⁴)COOR¹ (I)

where R¹ is an aromatic or aliphatic radical containing up to 15 carbon atoms, the substituents R², R³ and R⁴ independently of one another represent hydrogen, branched or unbranched, aliphatic or aromatic groups containing up to 20 carbon atoms or a group —(CH₂)ₙ—COOR¹, where R¹ is as defined above and n is a number of 0 to 10, with

(c) one or more mono-, di- or polyaminopolyalkylene oxide compounds, compounds (a) and (c) being used in such quantities that the equivalent ratio of the reactive hydrogen atoms at the aminonitrogen atoms of (c) to the C═C double bond in the α,β-position to the group COOR¹ shown in formula (I) in the carboxylic acid esters (a) is in the range from 10:1 to 1:10,

subsequently reacting the intermediate product Z4 obtained with

(g) one or more polyhydroxy compounds, the equivalent ratio of ester groups in the intermediate compound Z4 to hydroxy groups in the polyhydroxy compound (g) being adjusted to a value of 1:1.1 to 1:10,

and subsequently reacting the intermediate product Z6 obtained with

(d) one or more polyepoxides, the equivalent ratio of oxirane rings in polyepoxide (d) to hydroxyl groups in the intermediate product Z6 being adjusted to a value of 1.5:1 to 6:1,

and subsequently reacting the intermediate product Z7 obtained with

(e) one or more primary and/or secondary amines, the equivalent ratio of oxirane rings in the intermediate product Z7 to the reactive H atoms at the aminonitrogen atoms of (e) being adjusted to a value of 1:1.5 to 1:20.

The foregoing observations on hardeners of the B1) type otherwise apply to the substances (a) and to the substances (c) to (e).

The polyhydroxy compounds (g) may be aliphatic or aromatic. In one embodiment, the polyhydroxy compounds (g) are selected from the class of special aliphatic diols, namely alkanediols, especially dimer diols, polyether diols and polyester diols. The foregoing observations on hardeners of the B1) type in relation to component (b) apply to the alkanediols, including the dimerdiols, and the polyether diols. Polyesterdiols in the context of the invention are diols corresponding to the general formula HOCH₂—R⁷—CH₂OH, where R⁷ is a hydrophobic hydrocarbon radical which may be saturated or unsaturated, linear or branched and may also contain aromatic structural elements and in which one or more CH₂ units must each be replaced by a COO unit. They are normally produced by reacting difunctional polyols with dicarboxylic acids or anhydrides thereof. Commonly used polyols are ethylene glycol, propane-1,2-diol, butane-1,4-diol, hexane-1,6-diol. Typical dicarboxylic acids are succinic acid, adipic acid, phthalic anhydride. Hexane-1,6-diol adipic acid polyesters are particularly preferred.

In one embodiment, component B) is used in a quantity of 5 to 25% by weight.

Component C)

Component C) of the coating compositions according to the invention is formed by fibers.

As well-known to the expert, the term “fibers” is used as a collective term for elongate aggregates of which the molecules (or crystallites) are parallel throughout in the longitudinal direction of the molecule (or a straight lattice line). Fibers are either thread-like structures of limited length (single fibers or hairs) or substantially endless fibers (filaments) either individually or in bundled form.

The following fibers or mixtures thereof are particularly suitable as component C): Twaron 1091 and Twaron 1094.

The fibers C) are intended in particular to influence the properties of the coating compositions. Apart from the improvement in the chemical, thermal and mechanical properties of coatings, production-related properties are critically influenced by fibers. The coating compositions according to the invention also show positive effects in regard to processing behavior. The effect of the fibers C) in the coating compositions is, for example, that the fillers present in the compositions sediment only slowly, if at all, and above all not in the course of curing.

Through the presence of fibers C) in the compositions according to the invention, the mechanical properties of the coating compositions are considerably improved by comparison with fiber-free products. The compositions according to the invention contain the fibers C) in a quantity of 0.1 to 10% by weight, based on all the components of the coating composition. They are preferably used in a quantity of 0.1 to 5.0% by weight. The range from 0.1 to 2.5% by weight is particularly preferred because it leads to self-levelling coatings. Coating compositions with this particular percentage content of fibers give coatings which are far more flexible and show higher flexural strength, tensile strength and tear propagation resistances than fiber-free coating compositions. By contrast the coatings obtained without the addition of fibers are fragile and non-flexible so that their mechanical properties cannot be determined.

Component D)

Component D) of the coating compositions according to the invention is formed by wax-based so-called open-time extenders. Systems such as these are known to the expert (a definition of waxes can be found, for example, in U. Zoril, Ed., RÖMPP—Lexikon, Lacke und Druckfarben, p. 615, Georg Thieme Verl., Stuttgart, N.Y., 1998). Waxes in the form of aqueous emulsions or in solid supply forms on mineral support materials are used during processing to extend the open time and to increase the flexibility and plasticity of the filling and insulating compounds. The expression “waxes” encompasses both waxes in the narrower sense and fatty alcohols.

Corresponding wax-based processing additives are described in detail in R. Neumann, H. -G. Schulte, R. Höfer, Pulver, das Eigenschaften schaff, Bautenschutz und Bausanierung, Heft 3/1999, pp/22-27 and in U. Nagorny, Extension of workability of synthetic resin plasters with additives based on fatty raw materials; ConChem-Journal, No. 1/1994, pp. 23-26). Powder-form wax-based open-time extenders, more particularly fatty alcohols containing 16 to 72 carbon atoms per molecule on a solid support, are particularly suitable. In this connection, reference is specifically made to the disclosure of WO 98/49114. Particularly suitable wax-based open-time extenders are the products Loxanol® 842 DP (aqueous dispersion) and Loxanol® P (water-free powder-form solid) marketed by Cognis Deutschland GmbH, Düssledorf/DE.

In one embodiment, component D) is used in a quantity of 0.1 to 2.0% by weight, based on all the components of the coating composition.

Component E)

Component E) of the coating compositions according to the invention is formed by rheology additives. Any rheology additives known to the expert, preferably layer silicates or poly (meth)acrylates or cellulose ethers or so-called associative thickeners, may be used individually or in combination.

Layer silicates in combination with hydrophobically modified polyether urethanes (HEURs) or hydrophobically modified polyethers (HMPEs) are preferably used. Hydrophobically modified means that hydrophobic groups are present in the molecules of the classes of compounds mentioned. Particularly preferred HEURs are the solventless HEURs described in G. Schulte, J. Schmitz and R. Höfer, Additive für wäβrige Systeme und umwelffreudliche Lacke, Welt der Farben, 28-31 (December 1997) and the pseudoplastic HEURs described in DE-A-42 42 687.

In one embodiment, component E) is used in a quantity of 0 or 0.1 to 3.0% by weight, based on all the components of the coating composition.

Component F)

Component F) of the coating compositions according to the invention is formed by fillers. Examples of suitable fillers are silica sand, heavy spar, calcium carbonates, silicates, calcium sulfate, talcum, kaolin, mica, feldspar, metal oxides, aluminium hydroxide, aluminium silicates, carbon black, graphite, barium sulfate and the like. The fillers are used in a quantity of 5.0 to 70.0% by weight, based on all the components of the coating composition.

Component G)

Component G) of the coating compositions according to the invention (water) is used in a quantity of 0 or 0.1 to 12.0% by weight and preferably in a quantity of 1.0 to 10.0% by weight.

Component H)

Other additives and/or processing aids known to the expert may be used as component H) of the coating compositions according to the invention. Examples include pigments, cement, gravel, deaerators, defoamers, dispersion aids, antisedimenting agents, accelerators, free amines, flow control additives, conductivity improvers.

The present invention also relates to the use of the coating compositions described above as levelling and insulating compounds, more particularly in the building industry. The use of the coating compositions for floors is particularly preferred.

### EXAMPLES

1. Materials Used

Waterpoxy 751: an isolated amine adduct dissolved in water which is used for hardening epoxy resin emulsions and liquid standard epoxy resins (Cognis Deutschland GmbH, Düsseldorf/DE)

Twaron 1094: polyparaphenylene terephthalamide (Twaron Products GmbH, Wuppertal/DE), fiber length=1.1-1.7 mm

Bentone EW: rheology additive based on a highly purified, readily dispersible smectite (Rheox Inc., Hightstown, N.Y./USA)

Millisil W4: silica flour (Quarzwerke GmbH, Frechen/DE)

Schwerspatmehl C 14: barium sulfate (Sachtleben Chemie GmbH, Duisburg/DE)

Heucosin Grau (type G 3911 N): pigment composition (Dr. Hans Heubach GmbH, Langelsheim/DE)

Dowanol TPM: tripropylene glycol monomethyl ether, isomer mixture (Reininghaus-Chemie GmbH, Essen/DE)

Loxanol DPN: liquid emulsion for extending open time (Cognis Deutschland GmbH, Düsseldorf/DE)

Foamaster 223: defoamer for low-odor emulsion paints (Cognis Deutschland GmbH, Düsseldorf/DE)

DSX 1550: nonionic rheology additive for waterborne paints; polyurethane prepolymer in water/butoxydiglycol (Nopco)

Chem-Res E 97: epoxy resin based on bisphenol A (Cognis Deutschland GmbH, Düsseldorf/DE)

2. Formulations

### Example 1 (E1)

A mixture of the components listed in Table 1 was prepared by successively stirring the components together using a dissolver. 14 parts by weight of the resin Chem-Res E 97 (component A) of the coating composition according to the invention) were added to 100 parts by weight of this mixture.

TABLE 1

| Quantity | | |
|---|---|---|
| [% by weight] | Material | Component |
| 16.8 | Waterpoxy 751 | Hardener B) |
| 20.0 | Schwerspatmehl C 14 | Filler F) |
| 2.5 | Twaron 1094 | Fibers C) |
| 45.1 | Millisit W4 | Filler F) |
| 4.0 | Heucosin Grau | Pigment H) |
| 1.0 | Bentone EW, 3% solution | Rheology additive E) |
| | in water | |
| 0.8 | Foamaster | Defoamer H) |
| 0.8 | Loxanol DPN | Open time extender D) |
| 0.4 | Dowanol TPM | Open time extender D) |
| 0.1 | DSX 1550 | Rheology additive E) |
| 8.5 | Water | G) |

It is pointed out purely in the intrests of completeness that the quantity of water (component G of the coating composition according to the invention) present in the system as a whole does not of course correspond solely to the quantity shown in the last column of Table 1 because some water was of course also introduced via component B).

### Comparison Example 1 (C1)

A mixture of the components listed in Table 2 was prepared by successively stirring the components together using a dissolver. 14 parts by weight of the resin Chem-Res E 97 (component A) of the coating composition according to the invention) were added to 100 parts by weight of this mixture.

TABLE 2

| Quantity | | |
|---|---|---|
| [% by weight] | Material | Component |
| 16.8 | Waterpoxy 751 | Hardener B) |
| 20.0 | Schwerspat C 14 | Filler F) |
| — | Twaron 1094 | Fibers C) |
| 47.6 | Millisit W4 | Filler F) |
| 4.0 | Heucosin Grau | Pigment H) |
| 1.0 | Bentone EW, 3% solution in | Rheology additive E) |
| | water | |
| 0.8 | Foamaster | Defoamer H) |
| 0.8 | Loxanol DPN | Open time extender D) |
| 0.4 | Dowanol TPM | Open time extender D) |
| 0.1 | DSX 1550 | Rheology additive E) |
| 8.5 | Water | G) |

It is pointed out purely in the intrests of completeness that the quantity of water (component G of the coating composition according to the invention) present in the system as a whole does not of course correspond solely to the quantity shown in the last column of Table 2 because some water is of course also introduced via component B).

3. Performance Properties

The compositions of Example 1 and Comparison Example 1 were cured in the form of test specimens to the DIN Standards identified in Table 3. The mechanical properties were then determined, see Table 3.

TABLE 3

| Test method | E1 | C1 |
|---|---|---|
| Elongation in % to DIN 53455 | n.m. | 0.5 |
| Tensile strength in MPa to DIN 53455 | n.m. | 8 |
| Tear propagation resistance in N/mm to DIN 53515 | n.m. | 24 |
| Flexural strength in MPa to DIN 53452 | 9 | 10 |

n.m. = not measurable (test specimen broke when clamped in place)

In particular, the following observations were made in the case of the composition of Example 1:

Sedimentation of the fibers used was minimal.

Hardly any sediment was formed.

Compared with conventional systems and with the Comparison Example, the cured coating composition was distinguished by excellent mechanical strength and elasticity.

High layer thickenesses were readily achieved.

The coating composition was self-levelling immediately after the components had been combined.

1. Coating compositions containing
A) 5.0 to 50.0% by weight epoxy resins in the form of reaction products of bisphenol A and/or bisphenol F with epichlorohydrin,
B) 5.0 to 55.0% by weight water-dilutable epoxy resin hardeners,
C) 0.1 to 10.0% by weight fibers,
D) 0 or 0.1 to 5.0% by weight wax-based open-time extenders,
E) 0 or 0.1 to 5.0% by weight rheology additives,
F) 5.0 to 70.0% by weight fillers,
G) 0 or 0.1 to 20.0% by weight water and
H) 0 to 70% by weight other additives and/or processing aids,
the sum of the percentages by weight of components A) to H) coming to 100% by weight.

2. Compositions as claimed in claim 1, characterized in that epoxy resins liquid at 20° C. are used as component A).

3. Compositions as claimed in claim 1 or 2, characterized in that epoxy resins liquid at 20° C. in the form of reaction products of bisphenol A with epichlorohydrin are used as component A).

4. Compositions as claimed in any of claims 1 to 3, characterized in that component A) is used in a quantity of 5 to 30% by weight.

5. Compositions as claimed in claims 1 to 4, characterized in that component B) is used in a quantity of 5 to 25% by weight.

6. Compositions as claimed in any of claims 1 to 5, characterized in that component C) is used in a quantity of 0.1 to 2.5% by weight.

7. Compositions as claimed in any of claims 1 to 6, characterized in that component D) is used in a quantity of 0.1 to 2.0% by weight.

8. Compositions as claimed in any of claims 1 to 7, characterized in that component E) is used in a quantity of 0.1 to 3.0% by weight.

9. Compositions as claimed in any of claims 1 to 8, characterized in that component G) is used in a quantity of 1.0 to 12.0% by weight.

10. The use of the coating compositions claimed in any of claims 1 to 9 as levelling and insulating compounds.
